(19) United States
(12) Patent Application Publication
(10) Pub. No.: US 2015/0332199 A1
(43) Pub. Date: Nov. 19, 2015

(54) SYSTEM AND METHOD FOR COMMUNICATING REPORTS WITHIN AN ENTERPRISE TO EXTERNAL MODULES

(71) Applicant: Bank of America Corporation, Charlotte, NC (US)

(72) Inventors: Jay L. Olson, Frisco, TX (US); Joseph T. Pickering, Newark, DE (US)

(73) Assignee: Bank of America Corporation, Charlotte, NC (US)

(21) Appl. No.: 14/277,410

(22) Filed: May 14, 2014

(51) Int. Cl. G06Q 10/06; G06F 7/02

(52) U.S. Cl. CPC G06Q 10/06395; G06F 7/02

(57) ABSTRACT

An interface receives data from a plurality of data sources. A processor applies quality control rules to the data and compares the data to historical data. The processor determines whether the data is inconsistent the with historical data based on the comparison. When the data does not comply with the quality control rules or the data is inconsistent with the historical data, the processor generates a common exceptions report comprising an exception, wherein the exception comprises at least one of a fatal exception and a warning exception. If an exception is generated, the process determines whether the exception is fatal. When an exception is not generated, the interface communicates the data to a plurality of external modules. When a warning exception is generated, the interface communicates the data to at least one of the external modules and communicates the exception to at least one of the data sources. When a fatal exception is generated, the interface prevents communication of the data to the external modules and communicates the exception to at least one of the data sources.

### TECHNICAL FIELD

This invention relates generally to communicating reports, and more particularly to communicating reports within an enterprise to external modules.

### BACKGROUND

Enterprises utilizing financial data receive records from various sources. For example, the financial data may include consumer information from customer sources and credit information from credit sources. In conventional systems, each data source communicates the information within the enterprises separately and communicates the information to external modules separately.

### SUMMARY OF EXAMPLE EMBODIMENTS

According to embodiments of the present disclosure, disadvantages and problems associated with communicating reports within an enterprise to external modules may be reduced or eliminated.

In accordance with a particular embodiment of the present disclosure, an interface receives data from a plurality of data sources. A processor applies quality control rules to the received data and compares the received data to historical data. The processor determines whether the data is inconsistent with the historical data based on the comparison. When the data does not comply with the quality control rules or the data is inconsistent with the historical data, the processor generates a common exceptions report comprising an exception. The processor determines an exception type if the exception is generated, wherein the exception type comprises at least one of a fatal exception and a warning exception. When the exception is not generated, the interface communicates the received data to a plurality of external modules. When the warning exception is generated, the interface communicates the received data to at least one of the external modules and communicates the warning exception to at least one of the data sources. When the fatal exception is generated, the interface prevents communication of the received data to the external modules and communicates the fatal exception to at least one of the data sources.

In accordance with another embodiment of the present disclosure, a method for communicating reports to external modules includes: receiving, by an interface, data from a plurality of data sources; applying, by a processor, quality control rules to the received data; comparing, by the processor, the received data to historical data; determining, by the processor, whether the received data is inconsistent with the historical data based on the comparison; when the received data does not comply with the quality control rules or the received data is inconsistent with the historical data, generating, by the processor, a common exceptions report comprising an exception; determining, by the processor, an exception type if the exception is generated, wherein the exception type comprises at least one of a fatal exception and a warning exception; when the exception is not generated, communicating, by the interface, the received data to a plurality of external modules; when the warning exception is generated, communicating, by the interface, the received data to at least one of the external modules and communicating, by the interface, the warning exception to at least one of the data sources; and when the fatal exception is generated, prevent communicating, by the interface, of the received data the external modules and communicating, by the interface, the fatal exception to at least one of the data sources.

Certain embodiments of the present disclosure may provide one or more technical advantages. A technical advantage of one embodiment includes increasing the accuracy of information sent to external modules, which improves efficiency and reduces computer and network usage. As another example, a technical advantage of one embodiment includes automatically detecting errors in data and providing feedback to data sources about the errors. As yet another example, data from multiple data sources is analyzed to ensure consistency among the data sources.

Other technical advantages of the present disclosure will be readily apparent to one skilled in the art from the following figures, descriptions, and claims. Moreover, while examples of specific advantages have been enumerated above, various embodiments may include all, some, or none of the enumerated advantages.

### BRIEF DESCRIPTION OF THE DRAWINGS

For a more complete understanding of the present invention and for further features and advantages thereof, reference is now made to the following description taken in conjunction with the accompanying drawings, in which:

FIG. 1 illustrates a system for communicating reports within an enterprise to external modules; and

FIG. 2 illustrates an example method for communicating reports within an enterprise to external modules.

### DETAILED DESCRIPTION

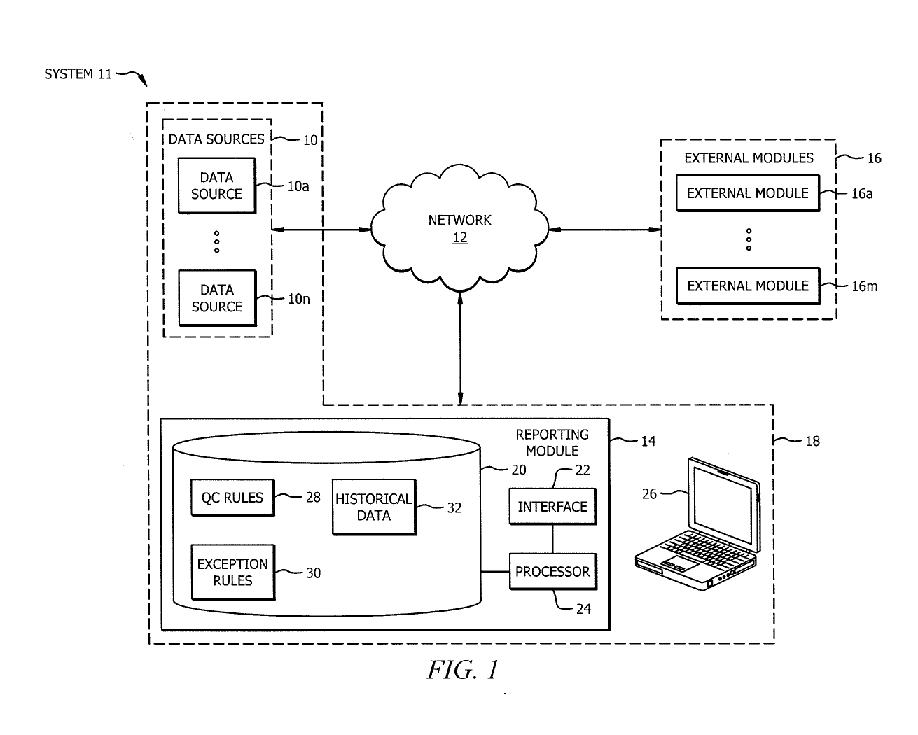

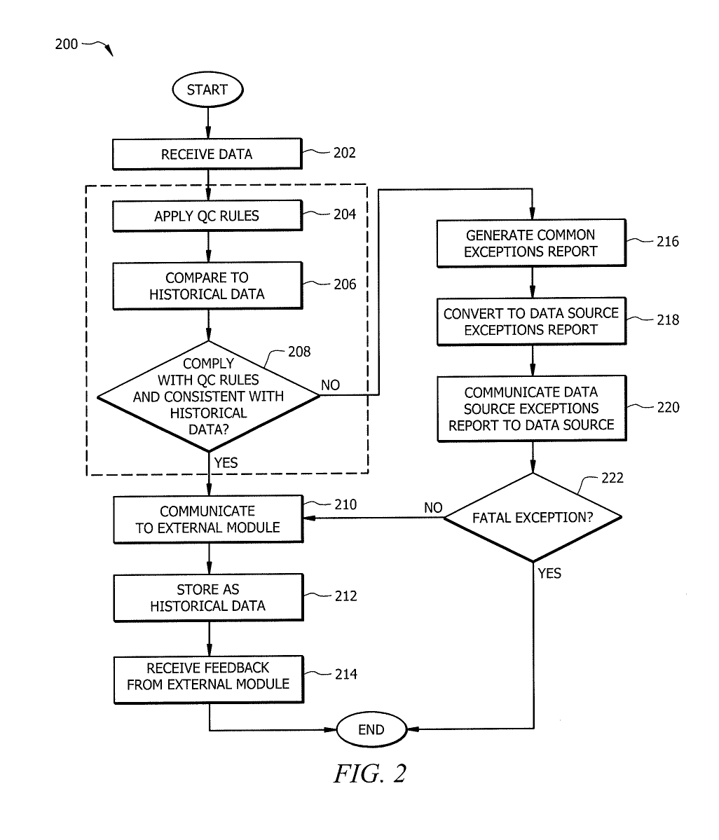

Embodiments of the present invention and its advantages are best understood by referring to FIGS. 1 and 2, like numerals being used for like and corresponding parts of the various drawings.

Enterprises utilizing financial data receive data from various sources. For example, the financial data may include consumer information from customer sources and credit information from credit sources. In conventional systems, each data source communicates the information within the enterprises separately. This data may include consumer data or credit data. Consumer data may include, but is not limited to, consumer deposits or any other suitable type of data. Credit data may include, but is not limited to, consumer credit cards, home loans, mortgages, auto loans, small business credit cards, recovery, military data, any other suitable type of data, or any combination of the preceding.

To facilitate providing financial services, enterprises may report the data to external vendors. Typically, each data source reports data separately to a plurality of external vendors. The teachings of this disclosure recognize that it would be desirable to provide a module that receives data from a plurality of data sources, analyzes the received data, and communicates the data to a plurality of external modules. The teachings of this disclosure also recognize that it would be desirable for the module to communicate feedback to a data source. Further, the teachings of this disclosure recognize that it would be desirable for the module to store and archive communicated data. This leads to more accurate data by allowing the module to communicate data errors and inconsistencies among a plurality of data sources. Additionally, the teachings of this disclosure provide for greater efficiencies in computer resources and network usage.

FIG. 1 illustrates a system for communicating reports within enterprise 18 to external modules 16. More specifically, system 11 includes data sources 10, enterprise 18, reporting module 14, external modules 16, and computer 26 that may be communicatively coupled by network 12. Generally, data sources 16, enterprise 18, reporting module 14, and computer 26 interact to efficiently communicate and analyze data to report to external modules 16.

System 11 may include data sources 10a-10n, where n represents any suitable number. Data sources 10 represent any source of information that may be used by reporting module 14 and/or components in enterprise 18. Data sources 10 may include a device (such as a database, a personal computer, a workstation, a laptop, a wireless or cellular telephone, an electronic notebook, a personal digital assistant, or any other device capable of receiving, processing, storing, and/or communicating information), a person (such as a person who has knowledge of an entity and who provides such knowledge for communication to reporting module 14), one or more documents (such as a spreadsheet that contains data), the Internet (which may include articles and other information containing data), an open source intelligence report, a media outlet such as a television station or a radio station that broadcasts information that may be communicated to reporting module 14), any other suitable source of information, or any combination of the proceeding. Data sources 10 may comprise data pertaining to consumer deposits, consumer credit cards, home loans, mortgages, automobile loans, small business credit cards, recovery, military, any other suitable type of data, or any combination of the preceding.

In certain embodiments, data sources 10 may apply quality assurance rules to data as data sources 10 are generating the data. For example, quality assurance rules may be applied to ensure that data is accurate and complete. In a further example, data sources 10 may communicate data to reporting module 14 for communication to external modules 16. Data sources 10 may communicate the data on demand or data sources 10 may communicate the data to reporting module 14 on a periodic basis or at any other suitable time determined by data sources 10, enterprise 18, reporting module 14, external modules 16, computer 26, or any other suitable component of system 11. Data sources 10 may be located within enterprise 18, external to enterprise 18, or any other suitable location.

System 11 includes external modules 16a-16m, where m represents any suitable number. External modules 16 may be located remote to enterprise 18 or any other location that allows for external modules 16 to communicate with enterprise 18, reporting module 14, computer 26, or any other suitable component of system 11 via network 12. In the illustrated embodiment, external modules 16 are associated with credit bureaus, such as Experian®, Equifax®, Transunion®, Innovis®, CHEX®, EWS®, ID Analytics®, or any vendor that reports credit or consumer information. Generally, external modules 16 represent any suitable components that facilitate the receiving and processing of communicated data from reporting module 14 and the communicating of feedback to reporting module 14. External modules 16 may communicate with enterprise 18 via network 12.

External modules 16 may include a network service, any suitable remote service, a mainframe, a host computer, a workstation, a web server, a personal computer, a file server, or any other suitable device operable to communicate with reporting module 14, enterprise 18, and computer 26. In some embodiments, external modules 16 may execute any suitable operating system such as IBM's zSeries/Operating System (z/OS), MS-DOS, PC-DOS, MAC-OS, WINDOWS, UNIX, OpenVMS, or any other appropriate operating systems, including future operating systems. The functions of external modules 16 may be performed by any suitable combination of one or more servers or other components at one or more locations. In the embodiment where the modules are servers, the servers may be public or private servers, and each server may be a virtual or physical server. The server may include one or more servers at the same or at remote locations. Also, external modules 16 may include any suitable component that functions as a server.

Network 12 facilitates communications between data sources 10, enterprise 18, reporting module 14, external modules 16, and computer 26. This disclosure contemplates any suitable network 12 operable to facilitate communication between the components of system 11. Network 12 may include any interconnecting system capable of transmitting audio, video, signals, data, messages, or any combination of the preceding. Network 12 may include all or a portion of a public switched telephone network (PSTN), a public or private data network, a local area network (LAN), a metropolitan area network (MAN), a wide area network (WAN), a local, regional, or global communication or computer network, such as the Internet, a wireline or wireless network, an enterprise intranet, or any other suitable communication link, including combinations thereof, operable to facilitate communication between the components of system 11. This disclosure contemplates end networks having one or more of the described properties of network 12.

System 11 includes enterprise 18. Enterprise 18 may refer to a financial institution, such as a bank. Enterprise 18 facilitates communicating information to data sources 10 and external modules 16 and receiving information from data sources 10 and external modules 16. In particular, enterprise 18 may facilitate communicating credit and consumer data to external modules 16. Further, enterprise 18 may communicate feedback to data sources 10 and receive feedback from external modules 16 via network 12. Even though enterprise 18 is referred to as a financial institution, enterprise 18 may include any suitable type of entity in any suitable industry.

Enterprise 18 may include reporting module 14 and computer 26. Reporting module 14 represents any suitable component that applies quality control rules to received data and provides feedback to data sources 10 based on the quality control rules. Reporting module 14 may include a network service, any suitable remote service, a mainframe, a host computer, a workstation, a web server, a personal computer, a file server, or any other suitable device operable to communicate with data sources 10, external modules 16, computer 26, or any other suitable component of system 11 via network 12. In some embodiments, reporting module 14 may execute any suitable operating system such as IBM's zSeries/Operating System (z/OS), MS-DOS, PC-DOS, MAC-OS, WINDOWS, UNIX, OpenVMS, or any other appropriate operating systems, including future operating systems. The functions of reporting module 14 may be performed by any suitable combination of one or more servers or other components at one or more locations. In the embodiment where the modules are servers, the servers may be public or private servers, and each server may be a virtual or physical server. The server may include one or more servers at the same or at remote locations. Also, reporting module 14 may include any suitable component that functions as a server.

In the illustrated embodiment, reporting module 14 includes interface 22, processor 24, and memory 20. Interface 22 represents any suitable device operable to receive information from network 12, transmit information through network 12, perform suitable processing of the information, communicate to other devices, or any combination of the preceding. For example, interface 22 transmits data to one or more external modules 16. As another example, interface 22 receives data from one or more data sources 10. As a further example, interface 22 receives feedback from external modules 16 and communicates the feedback to enterprise 18. In another example, interface 22 communicates feedback to data sources 10. Interface 22 represents any port or connection, real or virtual, including any suitable hardware and/or software, including protocol conversion and data processing capabilities, to communicate through a LAN, WAN, or other communication systems that allows reporting module 14 to exchange information with network 12, data sources 10, enterprise 18, computer 26, external modules 16, and other components of system 11.

Processor 24 controls the operation and administration of reporting module 14 by processing information received from interface 22 and memory 20. Processor 24 communicatively couples to interface 22 and memory 20. Processor 24 includes any hardware and/or software that operates to control and process information. For example, processor 24 may be a programmable logic device, a microcontroller, a microprocessor, any suitable processing device, or any suitable combination of the preceding.

Memory 20 may be a database that stores, either permanently or temporarily, received data, quality control (“QC”) rules 28, exception rules 30, historical rules 32, any other suitable data, or any combination of the preceding. Memory 20 includes any one or a combination of volatile or non-volatile local or remote devices suitable for storing information. For example, memory 20 may include Random Access Memory (“RAM”), Read-only Memory (“ROM”), magnetic storage devices, optical storage devices, or any other suitable information storage device or combination of these devices. Memory 20 may include any suitable information for use in the operation of reporting module 14. Additionally, memory 20 may be a component external to reporting module 14. Memory 20 may be located in reporting module 14, enterprise 18, or any other location suitable for memory 20 to communicate with reporting module 14.

Memory 20 may include QC rules 28. QC rules 28 generally refer to logic, rules, algorithms, code, tables, and/or other suitable instructions embodied in a computer-readable storage medium for performing the described functions and operations of reporting module 14. For example, QC rules 28 facilitate the determination of whether data received from one of the data sources 10 contains an exception. An exception may occur if data received by reporting module 14 does not comply with QC rules 28 or is inconsistent with historical data 32. For example, reporting module 14 may generate an exception if the received data is inconsistent with data received from other data sources 10 or historical data 32 or if the data contains an illogical condition. An illogical condition may occur if one field of the received data is inconsistent with another field of the received data. For example, an illogical condition may occur if one field of the data indicates that an account is current and another field of the received data indicates a missed payment. While illustrated as including a particular module, QC rules 28 may include any suitable information for use in the operation of reporting module 14.

Memory 20 may also include historical data 32. Historical data 32 represents previously communicated data that reporting module 14 stores. Additionally, an individual or entity may update reporting module 14 with updated information to store as historical data 32. Processor 24 may be configured to compare data received from data sources 10 to determine inconsistencies between the received data and historical data 32. Although historical data 32 is described in the same format as data received from data sources 10, reporting module 14 may manipulate, modify, or transform historical data 32 into other formats. Reporting module 14 may also add or delete historical data 32. Furthermore, reporting module 14 may store historical data 32 for a certain time period (e.g., historical data 32 may contain only the past 60 months of communicated data or any other appropriate length of time).

Memory 20 may further include exception rules 30. Exception rules 30 generally refer to logic, rules, algorithms, code, tables, and/or other suitable instructions embodied in a computer-readable storage medium for identifying whether an exception is a warning exception or a fatal exception and for converting an exceptions report into a data source exceptions report. In an embodiment, processor 24 and any other suitable components of reporting module 14 utilize exception rules 30 to manipulate the format and/or computer language of a common exceptions report. For example, processor 24 may apply exception rules 30 to a common exceptions report to generate a data source exceptions report. A data source exceptions report contains computer language and is in a format suitable for communicating the data source exceptions report to one or more particular data sources 10. In a further embodiment, exceptions rules 30 may be used to indicate whether an exception is a warning exception or a fatal exception. While illustrated as including a particular module, exception rules 30 may include any suitable information for use in the operation of reporting module 14.

As illustrated, enterprise 18 may also include computer 26. Computer 26 may be any device that interacts with system 11. For example, computer 26 may interact with reporting module 14 or data source 10 via network 12 to request data. In another example, computer 26 may interact with external modules 16 via network 12 to facilitate data communication. Computer 26 may use a processor and a memory to execute and to perform any of the functions described herein. Computer 26 may be a personal computer, a workstation, a laptop, a wireless or cellular telephone, an electronic notebook, a personal digital assistant, a table, or any other device (wireless, wireline, or otherwise) capable of receiving, processing, storing, and/or communication information with other components of system 11, or any combination of the preceding. Computer 26 may also include a user interface, such as a display, a touchscreen, a microphone, keypad, or other appropriate terminal equipment usable by a user.

A component of system 11 may include an interface, logic, memory, and/or other suitable element. An interface receives input, sends output, processes the input and/or output, and/or performs other suitable operations. An interface may comprise hardware and/or software. Logic performs the operations of the component. For example, logic executes instructions to generate output from input. Logic may include hardware, software, and/or other logic. Logic may be encoded in one or more non-transitory, tangible media, such as a computer readable storage medium or any other suitable tangible medium, and may perform operations when executed by a computer. Certain logic, such as a processor, may manage the operation of a component. Examples of a processor include one or more computers, one or more microprocessors, one or more applications, and/or other logic.

To better understand the functions of system 11, an example of communicating reports to external modules will be used. However, it is understood that system 11 may be used in a variety of contexts and areas to help reporting module 14, enterprise 18, data sources 10, and external modules 16 communicate data in an efficient matter, such as communicating data and transmitting feedback.

In one exemplary embodiment of operation, one or more data sources 10 communicates data to reporting module 14. The data may include any of the following data or any combination thereof: consumer deposits, consumer card, home loans, mortgages, automobile loans, small business credit cards, recovery, military, any other suitable type of data, or any combination of the preceding. The data sources 10, or any other suitable module, may apply quality assurance rules to the data before communicating with reporting module 14. The data may be in a number of formats including, but not limited to, CHEX Systems, Early Warning Services, International Development Association, Metro1 or Metro2 format. Quality assurance rules are generally applied by data sources 10 and may be applied as data sources 10 create a data file. Quality assurance rules ensure that data meets certain requirements before being communicated to reporting module 14.

In an embodiment, reporting module 14 receives the data through interface 22. Reporting module 14 may then apply QC rules 28 to the received data. QC rules 28 are applied to the data after it is compiled by data sources 10 and sent to reporting module 14. QC rules 28 may facilitate determining whether the data is consistent with data received from other data sources 10 or whether the data contains an illogical condition. If QC rules 28 are not met, reporting module 14 may produce an exception. An exception may indicate an error or potential error in the received data. If an exception is produced, reporting module 14 may use exception rules 30 and processor 24 to determine whether the exception is a warning exception or a fatal exception.

In an embodiment, reporting module 14 may compare the received data to historical data 32. Historical data 32 may be used to ensure that the received data is consistent with previously received data. For example, reporting module 14 may use historical data 32 to determine whether the data contains an inconsistency in whether a certain individual or entity was delinquent in certain time periods. Using historical data 32, processor 24 may also determine whether an individual or entity is frivolously disputing transactions. For example, reporting module 14 may determine whether an individual or entity developed a pattern for disputing transactions or whether the individual or entity is disputing the same transaction multiple times. If the received data is inconsistent with historical data 32 or the reporting module 14 determines that a particular transaction dispute is frivolous, then reporting module 14 may generate an exception. For example, reporting module 14 may generate an exception if the received data is inconsistent with data received from other data sources 10 or if the data contains an illogical condition.

If an exception is generated, reporting module 14 may use exception rules 30 and processor 24 to determine whether the exception is a warning exception or a fatal exception. For example, reporting module 14 may use exception rules 30 and processor 24 to generate a fatal exception, which may indicate that reporting module 14 should prevent communicating the received data to external modules 16. For example, exception rules 30 may instruct processor 24 or other suitable components of reporting module 14 to generate a fatal exception if one field of the received data indicates that an account is current and another field of the received data indicates that the customer missed a payment. As a further example, exception rules 20 may instruct processor 24 or other suitable components of reporting module 14 to generate a warning exception when a customer's name differs between the received data and historical data 32. It should be noted that the above examples illustrate example embodiments, and exception rules 30 can be configured to generate a warning exception or a fatal exception in any number of circumstances.

In certain embodiments, reporting module 14 communicates the received data to external modules 16 via network 12. Reporting module 14 may communicate the received data to external modules 16 when an exception is not generated by reporting module 14 or when a warning exception is generated by reporting module 14. Further, reporting module 14 may be designed to prevent the communication of the received data to external modules 16 when a fatal exception is generated.

If reporting module 14 generates an exception, reporting module 14 may generate a common exceptions report for communication to one or more data sources 10. The common exceptions report may detail an exception present in the received data as determined by reporting module 14. For example, the common exceptions report may detail an inconsistency between two or more data sources 10 or an illogical condition within the received data. Reporting module 14 may communicate the common exceptions report to one or more data sources 10. While still complying with appropriate affiliate sharing rules, the common exceptions report may be communicated to any number of data sources 10, including a broadcast message to all of the data sources 10. One or more data sources 10 may then utilize the common exceptions report to correct errors and/or inconsistencies in data. This allows for data sources 10 to increase data accuracy.

In another example, reporting module 14 may use exception rules 30 to convert the common exceptions report into one or more data source exceptions reports. For example, each of data sources 10 may be configured to receive data in a particular format or computer language. Reporting module 14 may use exception rules 30 and/or processor 24 to manipulate the common exceptions report into one or more data source exceptions report. The data source exceptions reports may then be communicated to one or more data sources 10. Complying with appropriate affiliate sharing rules, one or more data source exceptions reports may be communicated to any number of data sources 10 including a broadcast message to all of the data sources 10. One or more of data sources 10 may then utilize the common exceptions report to correct errors and/or inconsistencies in data. This allows for data sources 10 to increase data accuracy.

In a further embodiment, reporting module 14 may receive feedback from one or more external modules 16. For example, if one or more external modules 16 determines that a certain data file has not been updated within a specific time period, one or more external modules 16 may communicate with reporting module 14 via network 12 to indicate that the record is outdated. For example, if a data record is not updated in one or more external modules 16 within a certain time period (e.g., three months), then one or more external modules 16 may communicate to module 14 or enterprise 18 via network 12 that the data record is outdated. For example, a data record may become outdated when reporting module 14 generates a fatal exception and prevents communication of data to one or more external modules 16.

Modifications, additions, or omissions may be made to system 11 without departing from the scope of the invention. For example, system 11 may include any number of reporting modules 14, external modules 16, data sources 10, enterprises 18, or computers 26. As another example, reporting module 14 may communicate a request for a data report to one or more external modules 16. Furthermore, the components of system 11 may be integrated or separated. For example, reporting module 14 and data sources 10 may be incorporated into a single component.

FIG. 2 illustrates an example method for communicating reports within enterprise 18 to external modules 16. The method begins at step 202 when reporting module 14 receives credit data or consumer data from data sources 10. Before communicating the data to reporting module 14, data sources 10 may have already applied certain quality assurance rules to the data. At step 204, reporting module 14 applies QC rules 28 to the received data.

At step 206, reporting module 14 compares the received data to historical data 32. Historical data 32 may include data previously received by reporting module 14 (e.g., historical data 32 may contain only the past 60 months of past communicated data or any other appropriate length of time). Although historical data 32 is described in the same format as data received from the data sources 10, reporting module 14 may manipulate, modify, or transform, historical data 32 into other formats, and may add or delete historical data 32.

Reporting module 14 determines whether the received data complies with QC rules 28 and is consistent with historical data 32 at step 208. QC rules 28 may indicate whether the received data contains an illogical condition, is inconsistent with historical data 32 or other received data, or any other suitable determination. If the received data complies with QC rules 28 and is consistent with historical data 32, the method proceeds to step 210. However, if the received data does not comply with QC rules 28 or is inconsistent with historical data 32, the method proceeds to step 216.

If both conditions at step 208 are satisfied, the method proceeds to step 210 where reporting module 14 communicates the received data to one or more external modules 16 via network 12. At step 212, reporting module 14 stores the received data in memory 20 as historical data 32. The received data may then be referred to as historical data 32 as reporting module 14 receives subsequent data from data sources 10.

At step 214, reporting module 14 receives feedback from one or more external modules 16. For example, if a data record is not updated in one or more of external modules 16 within a certain time period (e.g., three months), then one or more of external modules 16 may communicate that the data record is outdated to reporting module 14 or enterprise 18 via network 12. A data record may become outdated when reporting module 14 generates a fatal exception and prevents communication of data to one or more external modules 16.

If one of the conditions in step 208 is not satisfied, the method proceeds to step 216 where reporting module 14 generates a common exceptions report, the common exceptions report comprising an exception. The common exceptions report may detail an exception present in the received data. For example, the common exceptions report may detail an inconsistency between two or more data sources 10 or an illogical condition within the received data. Interface 22 may communicate the common exceptions report to one or more data sources 10 or any other suitable component of system 11.

At step 218, reporting module 14 may convert the common exceptions report into one or more data source exceptions reports for communication to data sources 10. Each data source exceptions reports may comprise a format and/or computer language that is consistent with one or more data sources 10. At step 220, The data source exceptions reports are communicated to one or more data sources 10.

Reporting module 14 determines whether the exception is a fatal exception or a warning exception at step 222. If the exception is a fatal, reporting module 14 prevents interface 22, or any other component of reporting module 14, from communicating the received data to external modules 16, and the method ends. If the exception is not fatal, and merely a warning exception, then the method proceeds to step 210 as previously discussed.

Modifications, additions, or omissions may be made to the method depicted in FIG. 2. The method may include more, fewer, or other steps. For example, reporting module 14 may determine whether data complies with QC rules but not whether the data is consistent with historical data, or vice versa. As another example, reporting module 14 may not store the data as historical data. As another example, reporting module 14 may not receive feedback from external modules 16. As yet another example, steps may be performed in parallel or in any suitable order. While discussed as reporting module 14 performing the steps, any suitable component of system 11 may perform one or more steps of the method.

Although the present invention has been described with several embodiments, a myriad of changes, variations, alterations, transformations, and modifications may be suggested to one skilled in the art, and it is intended that the present invention encompass such changes, variations, alterations, transformations, and modifications as fall within the scope of the appended claims.

What is claimed is:

1. A system, comprising:
an interface operable to receive data from a plurality of data sources;
a processor communicatively coupled to the interface and operable to:
apply quality control rules to the received data;
compare the received data to historical data;
determine whether the received data is inconsistent with the historical data based on the comparison;
when the received data does not comply with the quality control rules or the received data is inconsistent with the historical data, generate a common exceptions report comprising an exception; and
determine an exception type if the exception is generated, wherein the exception type comprises at least one of a fatal exception and a warning exception; and
the interface further operable to:
when the exception is not generated, communicate the received data to a plurality of external modules;
when the warning exception is generated, communicate the received data to at least one of the external modules and communicate the warning exception to at least one of the data sources; and
when the fatal exception is generated, prevent communication of the received data the external modules and communicate the fatal exception to at least one of the data sources.

2. The system of claim 1, wherein:
the processor is further operable to convert the common exceptions report into a data source exceptions report; and
the interface is further operable to communicate the data source exceptions report to a data source associated with the data source exceptions report.

3. The system of claim 1, wherein the interface is further operable to receive feedback from an external module, the feedback indicating whether a report is outdated.

4. The system of claim 1, wherein the received data comprises one the following formats: METRO 1, METRO 2, CHEX, EWS, and IDA.

5. The system of claim 1, wherein the data sources comprise credit data sources and consumer data sources.

6. The system of claim 1, wherein quality assurance rules associated with the data source have been applied to the data before receipt.

7. Non-transitory computer readable medium comprising logic, the logic, when executed by a processor, operable to:
receive data from a plurality of data sources;
apply quality control rules to the received data;
compare the received data to historical data;
determine whether the received data is inconsistent with the historical data based on the comparison;
when the received data does not comply with the quality control rules or the received data is inconsistent with the historical data, generate a common exceptions report comprising an exception;
determine an exception type if the exception is generated, wherein the exception type comprises at least one of a fatal exception and a warning exception;
when the exception is not generated, communicate the received data to a plurality of external modules;
when the warning exception is generated, communicate the received data to at least one of the external modules and communicate the warning exception to at least one of the data sources; and
when the fatal exception is generated, prevent communication of the received data the external modules and communicate the fatal exception to at least one of the data sources.

8. The computer readable medium of claim 7, wherein the logic is further operable to:
convert the common exceptions report into a data source exceptions report; and
communicate the data source exceptions report to a data source associated with the data source exceptions report.

9. The computer readable medium of claim 7, wherein the logic is further operable to receive feedback from an external module, the feedback indicating whether a report is outdated.

10. The computer readable medium of claim 7, wherein the received data comprises one the following formats: METRO 1, METRO 2, CHEX, EWS, and IDA.

11. The computer readable medium of claim 7, wherein the data sources comprise credit data sources and consumer data sources.

12. The computer readable medium of claim 7, wherein quality assurance rules associated with the data source have been applied to the data before receipt.

13. A method, comprising:
receiving, by an interface, data from a plurality of data sources;
applying, by a processor, quality control rules to the received data;
comparing, by the processor, the received data to historical data;
determining, by the processor, whether the received data is inconsistent with the historical data based on the comparison;
when the received data does not comply with the quality control rules or the received data is inconsistent with the historical data, generating, by the processor, a common exceptions report comprising an exception;
determining, by the processor, an exception type if the exception is generated, wherein the exception type comprises at least one of a fatal exception and a warning exception;
when the exception is not generated, communicating, by the interface, the received data to a plurality of external modules;
when the warning exception is generated, communicating, by the interface, the received data to at least one of the external modules and communicating, by the interface, the warning exception to at least one of the data sources; and
when the fatal exception is generated, prevent communicating, by the interface, of the received data the external modules and communicating, by the interface, the fatal exception to at least one of the data sources.

14. The method of claim 13, further comprising:
converting, by the processor, the common exceptions report into a data source exceptions report; and
communicating, by the interface, the data source exceptions report to a data source associated with the data source exceptions report.

15. The method of claim 13, further comprising receive, by the interface, feedback from an external module, the feedback indicating whether a report is outdated.

16. The method of claim 13, wherein the received data comprises one the following formats: METRO 1, METRO 2, CHEX, EWS, and IDA.

17. The method of claim 13, wherein the data sources comprise credit data sources and consumer data sources.

18. The method of claim 13, wherein quality assurance rules associated with the data source have been applied to the data before receipt.
